(19) United States
(12) Patent Application Publication
(10) Pub. No.: US 2026/0279323 A1
(43) Pub. Date: Sep. 17, 2026

(54) SOUND-ABSORBING ACOUSTIC PANEL

(71) Applicant: KNAUF GIPS KG, Iphofen (DE)

(72) Inventors: Willibald NEUHERZ, Ferndorf (AT); Bruno WALKER, Weißenbach (AT)

(21) Appl. No.: 19/103,151

(22) PCT Filed: Aug. 12, 2022
(86) PCT No.: PCT/EP2022/025373

§ 371 Date: Feb. 11, 2025

(51) Int. Cl. G10K 11/168; B27N 3/00; B27N 3/04; B27N 3/06; B27N 3/12

(52) U.S. Cl. CPC G10K 11/168; B27N 3/002; B27N 3/04; B27N 3/06; B27N 3/12

(57) ABSTRACT

Acoustic panel, comprising a layer comprising wood wool and at least one binding agent, and a liner comprising a nonwoven based on glass fiber, characterized in that the nonwoven based on glass fibers has an airflow resistivity σ (ISO 9053-1:2018) of at least 5.00·10⁵ Pa-s/m²

The invention refers to a sound-absorbing acoustic panel, comprising a layer of a wood wool composite system and a nonwoven liner.

Mineral bonded wood wool boards—other expressions are WW boards, WW panels, (WW) lightweight panels—are building boards made of wood wool—usually long-fiber wood wool—and mineral binding agents (also synonymously called ‘binders’ hereinafter).

For this document, the expressions ‘board’ and ‘panel’ are understood synonymously, and the term ‘panel’ will be used consistently.

The amount of the binding agents is selected such that the wood wool shavings are bonded together and form a dimensionally stable, solid layer, but that no massive binder agent layer results. Instead, the lightweight panels are highly porous.

The panel can usually also be cut or sawed, for example. WW panels are used as indoors and outdoors insulating panels that can be plastered, or as acoustically effective ceiling and wall cladding, for example. Building panels on the basis of WW panels often comprise additional layers, in particular those that take over functional tasks. Multi-layer lightweight panels are used in particular for heat and sound insulation as well as for optimizing and improving room acoustics.

Soundproofing refers to blocking sound so that it can't travel from room to room, i.e. sound insulation. On the other hand, sound absorption refers to stopping sound from bouncing around a room, and accordingly to the room acoustics (sound damping). Room acoustics may be optimized by room paneling with good sound-absorbing properties. Room acoustics are optimized when the sound is highly absorbed and little reflected.

Room acoustics optimization can be evaluated using the sound absorption value aw (also called sound absorption coefficient) according to DIN EN ISO 11654 (identical to ISO 11654), which indicates the proportion of the absorbed portion of the sound absorbed by the insulating material is (0 means complete reflection, 1 means complete absorption).

The sound absorption coefficient can be separated into the following ranges or classes:

| Sound absorption class | | |
|---|---|---|
| according to | Verbal | sound absorption |
| DIN EN ISO 11654 | characterization | coefficient α_{W} |
| A | highly absorbing | ≥0.9 |
| B | highly absorbing | 0.8 to 0.85 |
| C | absorbing | 0.6 to 0.75 |
| D | absorbing | 0.3 to 0.55 |
| E | low absorbing | 0.15 to 0.25 |
| F¹⁾ | reflecting | ≤0.1 |

¹⁾designated as ‘not classified’ in DIN EN ISO 11654

Panels based on wood wool and an inorganic binder are often highly porous systems. The binder serves to mechanically hold the wood wool together, but usually does not form a closed, impermeable layer. Due to their low density and the cavities remaining between the bonded wood wool shavings, these panels have good insulating properties and a certain soundproofing effect, but these often do not meet the high requirements. The sound absorption class achieved is regularly D or C. Composite systems made of layers of different materials, one of which can be the wood wool composite system mentioned, and/or different structure are used so that the resulting composite panel has the desired properties. In this way, sound absorption class B or even A can be achieved.

Wood shavings are mechanically separated wood particles obtained from the wood during the sawing or planing process. The terms wood wool shavings refer to elongated, usually fine, thread-like or chip-like wood particles that are also obtainable from mechanical separation and are often splinter-free. Often only the general expression wood wool is used, in particular for an accumulation of wood wool shavings. Like the wood from which they are derived, wood wool and wood shavings are based on wood fibers. Wood fibers are elongated wood cells or wood cell composites that are part of the wood and serve the plant for its strength.

The individual design of the composite panels also depends on the intended use. German utility model DE 20 109 704 U, for example, shows a sound insulation element for floors in the form of a multilayer panel, wherein an outer layer of this panel consists of a wood wool lightweight material, and wherein this wood wool layer has raised sections. This sound insulation element is applied as a dry screed floating on the floor base. For sound insulation, the contact area between the element and the floor material shall be minimized. Wall and ceiling coverings are not described.

EP 971 080 B describes sound-absorbing composite panels in which a fiber mat, which may be made from mineral fibers, has a wood wool insulation panel bonded to one of its surfaces. A nonwoven, such as a glass nonwoven, is bonded to its other surface. The wood wool of the wood wool insulation panel may be bonded with a magnesitic binder.

The composite panels are to be used as sound insulation panels in tunnels, for example in railroad tunnels, between the rails.

EP 464 618 B, for example, presents insulation layers for wall or ceiling insulation. There, an air-permeable fibrous material layer is equipped with an air-permeable, bonded wood-wool layer on one or both sides, wherein the connection is made by partial bonding.

EP 2 006 462 B discloses acoustic multilayer panels. A layer comprising wood wool shavings serves as the core layer, the shavings being bonded with an inorganic binder.

On one of the surfaces of the wood wool layer, a perforated face layer is provided in the form of a prefabricated semi-finished product or of a cured monolithic mass. On the other surface of the wood wool layer, a mineral fiber overlay, a gypsum board or a glass fleece is applied. The non-perforated side of this multilayer board is used for its attachment to the ceiling or a wall.

With high permeability (porosity) of the wood wool panels, the thermal insulation properties could be improved, but at the expense of sound absorption. By using rock wool slabs as further layers, sound insulation could be significantly improved, and optimized products were obtained both in terms of thermal insulation and sound insulation.

One such product is available under the name HERADESIGN® Fine plus from Knauf Ceiling Solutions. This is a two-layer board consisting of a magnesite-bonded wood wool panel and a rock wool slab—as absorber—layer with trickle protection. In order to best optimize room acoustics, the absorber layer has approximately the same thickness as the wood wool panel, usually in the thickness range of a few centimeters, for example in the range of 2.5 to 5 cm.

Especially for the use in gymnasiums, sports halls and the like, acoustic panels have to show a high mechanical stability, in addition to the properties discussed above.

Furthermore, they must be easy to attach and to install. In particular, they have to be safe against ball throwing (hereinafter also called ‘ball-proof’). Building panels that remain durable under mechanical stress caused by balls without significant changes to the elements and their substructure, in particular comply with the relevant standards like DIN 18032-3:2018-11, are considered ball-proof.

Wall panels or ceiling panels are usually fixed to elements of a (sub-) construction, like rails, profiles or wooden battens. Since the sound absorbing rock wool slab needs to have a certain thickness to provide good room acoustics—see above—, it is not possible to securely fasten the panels through this layer to the construction rails. Therefore, the aforementioned panels with rock wool slabs are not suitable for use in the gymnasiums, for example. Such an application would mean that the rock wool slab would have to be recessed in the same distance of the construction rails. This would be disadvantageous for the acoustic effect—since the panel would comprise large areas without absorber layer—and would require an enormous amount of work during manufacture. Accordingly, due to the mineral wool applied to the back of the panel, it is not possible to install the panel crosswise to the construction elements. As a result, commercially available products for this application are ruled out for design reasons, since a support of 600 mm or 625 mm, as required by the relevant construction standards, cannot be maintained.

Last but not least rock wool fibers are regarded as harmful and carcinogen when having certain dimensions and concentrations. Therefore, in current Technical Rules for Hazardous Substances (TRGS) and similar regulations it is demanded to reduce artificial mineral fibers (AMF) of certain dimensions, or they are even completely forbidden.

Another requirement for acoustic panels refers to its fire classification, which should meet the relevant specifications.

Accordingly, there is a demand for sound absorbing acoustic panels which do not have the above-mentioned disadvantages or only have them to a lesser extent, and/or which fulfill the above-mentioned requirement profile. Such acoustic panels should be suitable for gymnasiums, sport halls and/or multi-purpose-halls. Preferably, the positive properties of acoustic panels according to the state of the art, like fire integrity, should not be significantly worsened.

Unexpectedly, it was found that a sound absorbing acoustic panel (hereinafter shortly referred to as ‘acoustic panel’) according to the main claim, and such according to the dependent claims, have the desired properties to solve said problem. The sound-absorbing acoustic panel according to the invention is a panel for optimizing room acoustics. According to the main claim, the acoustic panel comprises a layer comprising wood wool and at least one binder agent, and a liner comprising a nonwoven based on glass fibers. Preferably, the liner comprises a nonwoven based on glass fibers and cellulose fibers.

The layer comprising wood wool contains binder agent in an amount to ensure that the layer is dimensionally stable in the hardened and, if applicable, pressed shape and forms a solid panel. Advantageously, the hardened binder agent system builds no massive and closed layer, but is added in a small amount just sufficient to bond the wood wool shavings to each other, but to allow the layer to remain porous or even highly porous. By this, it is ensured that the layer is dimension stable (stable in shape) as demanded, but also have best possible sound absorption properties and a small dead weight

The layer of the acoustic panel according to the invention, which comprises wood wool and at least one binding agent, is hereinafter referred to as ‘wood wool panel’.

Within the scope of this document, nonwovens based on glass fibers are referred to as ‘glass fiber nonwovens’, independent of any other fibers that may be present in the nonwoven. The glass fiber nonwoven serves as a sound absorber. This means it improves the room acoustics optimizing properties of the acoustic panel according to the invention, compared to the pure wood wool panel. The glass fiber nonwoven is a nonwoven according to the definition in EN 29092 (DIN EN 29092:1992-08). According to the invention, it comprises glass fibers. Preferably, the amount of glass fibers in the glass fiber nonwoven is at least half the amount of all present fibers, or even more. The glass fiber nonwoven is a porous material.

In one aspect of the invention, all fibers that are present in the glass fiber nonwoven are glass fibers. In an alternative, preferred aspect of the invention, the glass fiber nonwoven also comprises one or more other fibers. However, advantageously, rock wool fibers as well as other harmful AMF-fibers are absent and therefore not components of the glass fiber nonwoven. Glass fibers present in the glass fiber nonwoven are preferably selected such that they are neither classified as harmful nor as cancerogenic, due to their dimensions. Accordingly, the presence of harmful artificial mineral fibers can be avoided.

The glass fiber nonwoven can be prefabricated, and therefore represent a separate entity, which normally will be the case. However, it is also possible that the glass fiber nonwoven is produced during the production of the acoustic panel according to the invention (in situ, without representing a separate object before).

Even at very low thicknesses, the glass fiber nonwoven that is used according to the invention possesses sound-absorbing properties which correspond to those of formerly used much thicker rock wool slabs (when latter have a thickness of 25 mm, for example).

Accordingly, in accordance with the invention, a glass fiber nonwoven having a thickness of less than 2.0 mm is preferred for the acoustic panel, more preferred of less than 1.0 mm, and even more preferred of less than 0.3 mm. This has made it possible to reduce the total thickness of the acoustic panel by nearly a half, while maintaining or even improving the room acoustics optimizing properties.

The thickness of the glass fiber nonwoven preferably is smaller by at least one power of ten, in preferred cases almost two powers of ten, compared to the thickness of the wood wool panel (for example, more than factor 83 for a preferred realization of the invention, in which the wood wool layer has a thickness of 25 mm and the glass fiber nonwoven liner has a thickness of less than 0.3 mm). Therefore, the glass fiber nonwoven of the acoustic layer is regarded as a liner of the wood wool panel, and not as an individual layer, as the latter is the case with the common rock wool slabs.

The glass fiber nonwoven is firmly and durably bonded by an adhesive means to one surface of the wood wool panel. The adhesive means may be—or be identical to—the binding agent that is already used for the wood wool panel. Alternatively or in addition, an additional adhesive or a glue may be used as the adhesive means.

The adhesive means completely bonds at least the surface of the glass fiber nonwoven with the wood wool panel, preferably by full-surface fixation, and in addition, it optionally may be penetrated into the glass fiber nonwoven to a certain degree. The insertion can improve the anchorage. However, the penetration depth should be kept quite low, for not to excessively reduce the absorption capacity of the glass fiber nonwoven. Therefore, the adhesive means preferably is only penetrated into a margin area of the nonwoven at it's surface. The possible insertion depth without loss of quality depend on the total thickness of the glass fiber nonwoven and the remaining thickness of the portion free of adhesive means (non-penetrated).

Preferably, the glass fiber nonwoven comprises cellulose fibers in addition to the glass fibers. The glass fiber—cellulose fiber nonwoven may be limited to glass fibers and cellulose fibers, however, one of more further (different) fibers may also be also present.

However, again, rock wool fibers and harmful AMF fibers are not present in the glass fiber—cellulose fiber nonwoven.

In the scope of this text, and in accordance with what has already been said, glass fiber-cellulose fiber nonwovens are comprised when referred to glass fiber nonwovens, unless otherwise individually stated.

The airflow resistance, the specific airflow resistance and the airflow resistivity are parameters that influence the sound absorption, and that can be used to characterize it.

If there is a pressure difference Δp [Pa] between the two surfaces of the (porous) absorption layer—in the present case: the glass fiber fleece—the air flows through the absorption layer at a volumetric airflow rate qᵥ, and, referred to the traversed surface A of the absorption layer, at a velocity u=qᵥ/A.

The ratio of the pressure difference Δp to volumetric airflow rate qv is called the airflow resistance R, with R=Δp/qv, and the ratio of the pressure difference Δp to the flow velocity u is called the specific flow resistance R_{S} with R_{S}=R·A=Δp/u.

This resistivity R_{S} depends on the thickness of the absorbing layer (as the thickness increases, the resistivity increases). The flow resistivity R_{S} divided by the thickness d of the absorption layer is called the airflow resistance σ and can serve as a standardized parameter of the considered layer, σ=R_{S}/d.

Units: [p]=Pa; [Δp]=Pa; [qv]=m³/s; [u]=m/s; [A]=m²; [RS]=Pa·s/m; [r]=Pa·s/m² Derived SI units are allowed as well.

Accordingly, values of specific airflow resistance RS and airflow resistivity σ specified herein refer to the measurement as disclosed in ISO 9053-1:2018.

According to the invention, the glass fiber nonwoven has an airflow resistivity σ according to ISO 9053-1:2018 (chapter 3.3) of at least 5.00·10⁵ Pa·s/m², preferably of at least 1.00·10⁶ Pa·s/m², more preferred of at least 3.00·10⁶ Pa·s/m².

Advantageously, the specific airflow resistance R_{S} according to ISO 9053-1:2018 (chapter 3.2) is at least 1000 Pa·s/m.

The acoustic panel recording to the invention as excellent room acoustics optimizing performance and is classified in sound absorption class A (DIN EN ISO 11654).

In addition to its excellent room acoustics optimizing performance, the acoustic panel according to the invention has good sound insulating properties.

The layer comprising wood wool and at least one binding agent is preferably a bonded wood wool layer, i.e. a wood-wool panel. In principle, all prefabricated bonded wood-wool panels known from the state of the art are suitable for this purpose. Alternatively, it is possible to produce the wood wool panel by harden a respective mixture of the materials to produce the glass fiber nonwoven directly on the glass fiber nonwoven. As wood wool panel, such panels based on wood wool shavings, wherein the shavings are or will be connected via an inorganic binder to form an open-pored structure, are particularly suitable. A wood wool lightweight panel is particularly preferably used for this layer.

Wood wool that is very suitable for the wood wool panels bases on conifers and/or softwoods, for example on spruce or pine. In principle, however, there are no restrictions in this respect.

The wood wool panel can be limited to its basic components wood wool and binder system (one or more binding agents, respectively). When producing the wood wool panel, it is possible to use production aids, like water as solvent or suspending agent for the binder system, and/or water of hydration in the binder system. This can remain at least partially as crystal water and/or residual moisture in the plate.

It is possible that the wood wool panel comprises further components, like wood fibers and/or textile fibers or the like.

Additives may be present in the wood wool panel, like fire retardants, fire protection agents and pesticides.

As already mentioned, wood wool is based on a plurality of wood shavings. Preferred wood shavings of the wood wool usually have a length of more than 8 cm, a width of 1 to 4 mm and a thickness of 0.2 to 0.5 mm. The individual wood shavings have a high open porosity, due to wood fibers being the basic material of the wood. The brittle wood wool shavings, which are present in irregular geometry, are irregularly distributed within the wood wool panel in the form of an open-pored, three-dimensional framework and are bonded to one another, at least in sections, by a binder system (one, two, three or more binding agents).

Inorganic or organic binders can be used as binding agents for the wood wool panel. Inorganic, especially mineral binder is preferred, such as caustic calcined magnesite (caustic magnesite), magnesite, magnesium sulfate, magnesium hydroxide, calcium carbonate, cement, gypsum, for example. It is also possible to use combinations of two or more binders, preferably binders from the list given above. If binder systems comprising more than one binder are used, often one of the binders is chosen in a high amount, compared to the other binders, whereas the other binders may be present as co-binders is essentially lower amounts.

The wood wool panel as used according to the invention preferably has a thickness in the range of 15 to 35 mm, for example 25 mm. In principle, a panel can also be made up of two or more thinner panels, instead of using a single-layer panel. Preferably, then the thickness of the combination of thinner panels has a thickness in the aforementioned range.

The natural, characteristic texture of wood wool is ideal as a surface for creative color design, so that the surface of the wood wool panel can be visually designed as desired, such as painted.

Wood wool panels which are commercially available from the Knauf Ceiling Solutions Company under the trade names HERADESIGN® Fine or HERADESIGN® Superfine are very suitable as wood wool panels for the invention, and are advantageously used. They are one-layered, magnesite-bonded wood wool panels, wherein the width of the wood wool fibers is 2 mm (fine) or 1 mm (superfine). These panels are available in different thicknesses and dimensions. The binder system comprises caustic magnesite (as main component) and co-binders.

The wood wool panel and the glass fiber nonwoven covering are firmly connected to each other at the contact area, preferably over the entire surfaces. For this fixation, a separate intermediate connection layer, for instance a layer of an adhesive or a glue layer, may be present in between the wood wool panel and the glass fiber nonwoven liner. Alternatively, the wood wool panel and the glass fiber nonwoven covering are connected to each other without an intermediate layer. For example, the binder system of the wood wool panel can also be used to bond the glass fiber nonwoven (for instance a glass fiber—cellulose fiber nonwoven). A possible process to receive such a connection and to produce an acoustic panel without an intermediate layer is discussed below.

Preferably, the total thickness of the acoustic panel according to the invention, perpendicular to their main surface, is in the range of 15 to 40 mm, more preferably of 15 to 26 mm, even more preferably of 15 to 25.3 mm. The panel size preferably corresponds to the usual grid dimensions, for instance 600-600 mm, 625-625 mm, 1200-600 mm or 1250-625 mm. Other dimensions are possible as well.

The acoustic panel according to the invention complies with the relevant fire protection regulations, the fire behavior corresponds at least to the classification Euroclass “B-s1, d0” according to EN 13501-1 (DIN EN 13501-1:2019-05). The acoustic panel is flame retardant, shows no smoke development and no burning dripping/falling off under the specifications mentioned therein.

The acoustic panel according to the invention is ball-proof (safe against ball throwing) according to DIN 18032-3:2018-11 chapter 2.1 (characterized as “ballwurfsicher”) as well as according to EN 13964 supplement D (DIN EN 13964:2014-08). In particular, the acoustic panel complies with class A1 according to this standard. Therefore, the panel is perfectly suitable as suspended ceiling as well as paneling or wall covering in sport halls, gymnasiums and halls for sports and multipurpose use.

A further advantage of the acoustic panel according to the invention, also favorable for the aforementioned use, results from the fact that the glass fiber nonwoven is extremely thin. Therefore, the attachment to construction frames or construction rails or to other suspension devices is not restricted, but may be realized easily with the thin glass fiber nonwoven liner by resulting. This leads to durable and safe anchorage. In contrast to thick acoustic panels made with rock wool slab according to the state of the art, the acoustic panel according to the invention does not require any undercut of the nonwoven, i.e. no offset or shift of the nonwoven to the edge of the wood wool panel. The srewing of the acoustic panel to (sub-) construction elements or to suspension devices can be realized through the acoustic panel-including the nonwoven liner-without leading to a lack of stability. Other nonwoven recesses are also not necessary for a safe attachment.

Accordingly, the acoustic panels according to the invention have an absorption effect over their full surface, and in addition, there is no longer a restriction concerning the size an span of the acoustic panels and concerning their alignment, since the srewing can take place everywhere. Further, the number of abutting edges may be reduced. These advantages lead to the fact that the acoustic panel is perfectly suitable for e.g. gymnasiums where good stability and good ball-proofness is necessary, to comply with the relevant standards.

Of course it is possible to also provide the second surface of the wood wool panel with a respective glass fiber nonwoven as described herein, if this is desired. However, in many cases, this is not necessary for most performance demands, and often could even be disadvantageous. Nevertheless, an acoustic panel having two liners of glass fiber nonwoven, one on each of it's surfaces, also belongs to the scope of this invention.

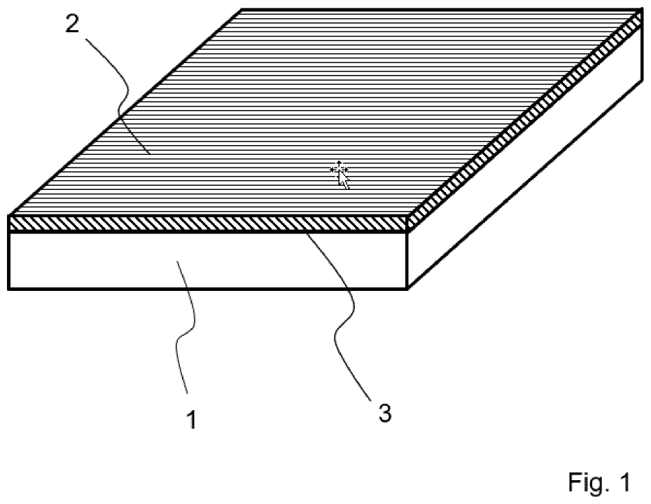

FIG. 1 shows schematically a sound-absorbing acoustic panel according to the invention, without intending to be limited in the inventive teachings by the principle presentation. At least a layer 1 comprising wood wool and at least one binding agent as well as a liner 2 comprising a nonwoven based on glass fibers, especially based on glass fibers and cellulose fibers, are connected with each other having a common contact area (3), to build an acoustic panel. In particular, the individual components are those described in more detail in this document.

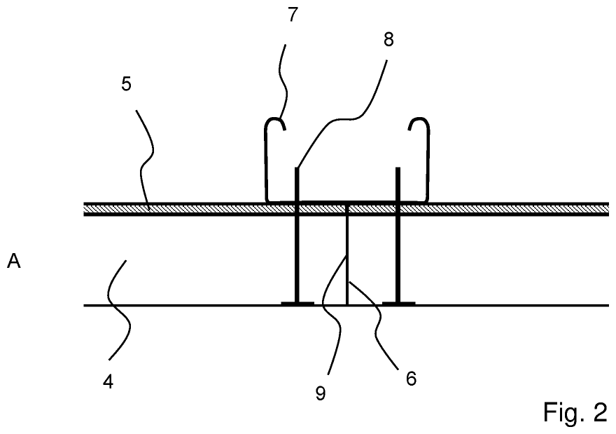

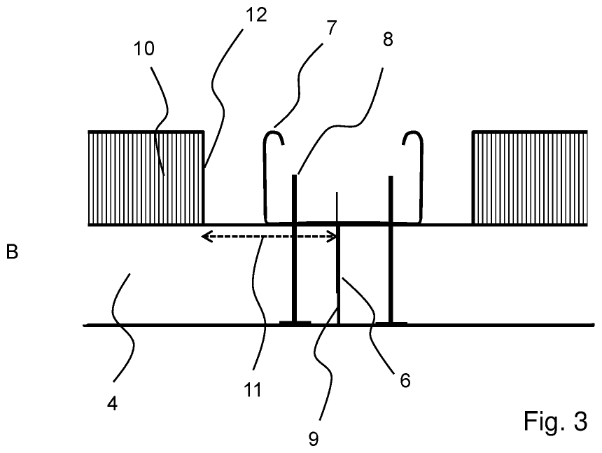

FIGS. 2 and 3 show schematically the advantages of the acoustic panel according to the invention (FIG. 2) compared to the situation when using a rock wool slab (FIG. 3), each of the two cases showing a cross-sectional view. Again, the embodiments as shown herein are examples only, and are not intended to restrict the invention unnecessarily.

According to FIG. 2, an acoustic panel (A) according to the invention is used. Two wood wool panels (4), each having a liner (5) comprising a glass fiber nonwoven (preferably a glass fiber-cellulose fiber nonwoven) abut (9) in the region of the substructure elements at the edges (6) of the wood wool panels (4). The panels are screwed (8) to the lower parts of suspension devices (7) through the acoustic panel A. The upper parts of the suspension devices (7) advantageously are shaped to engage with a support system, suitable ceiling eyelets or the like. Alternatively, the direct screwing to substructures elements as CD profiles, wooden battens or the like is possible likewise.

As already mentioned, it is possible as well to install acoustic panels (A) with high area dimensions, since no abutting edges (6) are necessary anymore at the suspension point (the position of substructure elements). In FIG. 2, the abutting edge line (6) would be omitted then.

FIG. 3 shows how an acoustic panel (B) according to the state of the art is attached. Herein, the wood wool panels (4) are provided with sound-insulating rock wool slabs (10).

At the abutting edge (9) of the wood wool panels (4), an offset (11) of the edges (12) of the rook wool slabs (10) to the edges (6) of the wood wool panels (4) is necessary to ensure a secure screwing (8) of the acoustic panels to the suspension devices/substructure elements (7), and to ensure a secure installation of the acoustic panels (B) at the abutting edge region. A screwing through the rock wool slab (10) would not be possible and not lead to sufficient stability.

An aspect of the invention refers to an advantageous process to produce the acoustic panels. In this process, the glass fiber nonwoven is provided and the materials for producing the wood wool nonwoven layer—in particular the wood wool shavings and the (mineral) binder system—is applied thereon and formed into a layer. Preferably, the layer has a thickness as disclosed for the wood wool panel above. Subsequently, the binder system hardens or is hardened by activation.

The wood wool, the binders used (the binder system) and usually a suspending agent, as especially water, is mixed in advance in a mixer to prepare the required base formulation.

In a preferred manner, at first a binder suspension is made from the binding agents and the suspending agent, and subsequently the wood wool is mixed into this suspension.

In a particularly preferred way, a belt forming machine is used. In a belt forming machine, flat bodies can be produced by applying the basic material on a-especially moving or movable-belt, in particular between two belts (a lower and an upper belt) and optionally two side belts. The flat raw product is formed by pressing and/or passing through a slit, a slit nozzle or the like. To receive the flat body, further processing like curing, setting, drying or the like can be necessary. The belt can be moved continuously or discontinuously through the process stations.

In respect to the preferred process, the glass fiber nonwoven is brought onto the lower steel belt of a belt forming machine directly during the production process. The moist formulation—including wood wool shavings and suspension of inorganic binders, preferably prepared as described above—is dispersed or applied onto the glass fiber nonwoven. The system may be enclosed by a second horizontal steel belt and two side bands. Optionally, the moist, shaped formulation passes through a setting channel to be dried. An endless strand is produced when leaving the double belt system. The strand can be cut or sewed to panels of the desired lengths.

During said pressing step, the glass fiber nonwoven is sufficiently wetted by the moist formulation, and the formulation may slightly penetrate the nonwoven. This leads to a durable adhesion (fixation) of the glass fiber nonwoven to the wood wool panel, once it is dried and the binder is hardened. Just a thin area of the nonwoven should be penetrated.

This procedure has the advantage that the hardening binder system itself serves as adhering means, effecting the fixation of the glass fiber nonwoven liner to the wood wool panel. Accordingly, no further adhesive is necessary. Intermediate layers are avoided.

However, it is also possible to prefabricate the wood wool panel, or to use commercially available wood wool panels—for example the above mentioned HERADESIGN® products—and to fix the glass fiber nonwoven by using a suitable adhesive or glue.

A further aspect of the invention refers to the use of a glass fiber nonwoven, especially of a glass fiber—cellulose fiber nonwoven, as a component of a sound-absorbing acoustic panel or for the production of a sound-absorbing acoustic panel, especially in form of a liner of a wood wool panel, wherein the glass fiber nonwoven has an airflow resistivity σ according to ISO 9053-1:2018 (chapter 3.3) of at least 5.00·10⁵ Pa·s/m², preferably of at least 1.00·10⁶ Pa·s/m², more preferred of at least 3.00·10⁶ Pa·s/m². Preferably, a glass fiber nonwoven according to any of the above-mentioned advantageous aspects is used.

A further aspect of the invention refers to the use of a glass fiber nonwoven, especially of a glass fiber—cellulose fiber nonwoven, as component of a sound-absorbing acoustic panel or for the production of a sound-absorbing acoustic panel, especially in form of a coating of a wood wool panel, wherein the glass fiber nonwoven has specific airflow resistance R_{S} according to ISO 9053-1:2018 (chapter 3.2) of at least 1.00·10³ Pa·s/m, and wherein the thickness of the glass fiber nonwoven is not larger than 1.0 mm, preferably not larger than 0.5 mm. Preferably, a glass fiber nonwoven according to any of the above-mentioned advantageous aspects is used.

Advantageously, the acoustic panel according to the invention is used as acoustic building board in the field of drywall construction, especially to optimize room acoustics and/or for sound insulation. It can be used as ceiling or wall paneling, for instance for suspended ceilings or wall coverings.

With the acoustic panels according to the invention, the performance of the panel for room acoustics optimization is significally improved, compared to a pure wood wool panel, without significally increasing the panel's thickness.

Compared to commercially available acoustic panels comprising wood wool panels and rock wool slabs, it is possible to at least maintain or even improve the panel's performance of the panel for room acoustics optimization, while significantly reducing the overall panel thickness.

At the same time, an advantageous production process is provided, and some further applications have become available, such as use in sports halls.

1. An acoustic panel, comprising
a layer comprising wood wool and at least one binding agent, and
a liner comprising a nonwoven based on glass fiber,
wherein
the nonwoven based on glass fibers has an airflow resistivity σ (ISO 9053-1:2018) of at least 5.00·10⁵ Pa·s/m2

2. The acoustic panel according to claim 1,
wherein
the nonwoven based on glass fibers has an airflow resistivity σ (ISO 9053-1:2018) of at least 1.00·10⁶ Pa·s/m², preferably of at least 3.00·10⁶ Pa·s/m²,
and/or
the nonwoven based on glass fibers has a specific airflow resistance R_{S} (ISO 9053-1:2018) of at least 1000 Pa·s/m.

3. The acoustic panel according to claim 1, wherein
the nonwoven based on glass fibers has a thickness of not more than 1.0 mm, preferably not more than 0.3 mm, perpendicular to the main surfaces of the acoustic panel.

4. The acoustic panel according to claim 1, wherein
its total thickness is 10 to 40 mm, preferably 15 to 5.3 mm, perpendicular to the main surfaces of the acoustic panel,
and/or
the layer comprising wood wool and at least one binding agent hast a thickness of 15 to 35 mm, perpendicular to the main surfaces of the acoustic panel.

5. The acoustic panel according to claim 1, wherein
the thickness of the nonwoven based on glass fibers is smaller by at least one power of 10, preferably is smaller by at least a factor of 80, than the thickness of the layer comprising wood wool and at least one binding agent.

6. The acoustic panel according to claim 1, wherein
the nonwoven based on glass fibers further comprises cellulose fibers.

7. The acoustic panel according to claim 1, wherein
the liner comprising a nonwoven based on glass fibers consists of exactly this nonwoven.

8. The acoustic panel according to claim 1, wherein
the liner comprising a nonwoven based on glass fibers is fixed by an adhesive means to the layer comprising wood wool and at least one binding agent, especially wherein the adhesive means is identical to the at least one binding agent of the layer comprising wood wool and at least one binding agent.

9. The acoustic panel according to claim 1, wherein
the at least one binding agent is an inorganic binding agent, especially a mineral binding agent, preferably wherein the mineral binding agent is cement or magnesite, in particular caustic calcined magnesite.

10. The acoustic panel according to claim 1, wherein
the layer comprising wood wool and at least one acoustic binding agent further comprises one or more co-binding agents.

11. The acoustic panel according to claim 1, wherein
the wood wool consists of or comprises wood wool shavings having a length of more than 8 cm, a width of 1 to 4 mm and a thickness of 0.2 to 0.5 mm.

12. A method for producing an acoustic panel according to claim 1, wherein
a nonwoven based on glass fibers is brought onto a steel belt of a belt forming machine,
a moist formulation comprising wood wool shavings and a suspension of one or more binding agents in a suspending agent, in particular in water, is applied onto the nonwoven,
the moist formulation wets and optionally penetrates into the nonwoven based on glass fibers by a pressing step,
and subsequently the formulation hardens by a reaction of the binding agent and/or a drying process.

13. Use of a nonwoven based on glass fibers as a component of an acoustic panel according to claim 1, preferably realized as a liner to a panel based on wood wool and a binding agent.
